(19) United States
(12) Patent Application Publication
(10) Pub. No.: US 2019/0352498 A1
(43) Pub. Date: Nov. 21, 2019

(54) POLYMER COMPOSITION COMPRISING POLYCARBONATE AND ABS WITH IMPROVED HEAT AGEING AND SURFACE APPEARANCE PROPERTIES

(71) Applicant: SABIC GLOBAL TECHNOLOGIES B.V., BERGEN OP ZOOM (NL)

(72) Inventors: Jiaoyan ZHOU, Geleen (NL); Wei SHAN, Geleen (NL); Miao SHEN, Geleen (NL)

(21) Appl. No.: 16/466,470

(22) PCT Filed: Dec. 4, 2017
(86) PCT No.: PCT/EP2017/081348

§ 371 Date: Jun. 4, 2019

(30) Foreign Application Priority Data
Dec. 6, 2016 (EP) 16202337.8

(51) Int. Cl. C08L 69/00

(52) U.S. Cl. CPC C08L 69/00; B29C 45/0001; C08L 2205/035; C08L 2205/025

(57) ABSTRACT

The invention relates to a process for the preparation of a final heterophasic propylene copolymer (A) having a final melt flow rate in the range from 65 to 110 dg/min, comprising visbreaking an intermediate heterophasic propylene copolymer (A′) having an intermediate melt flow rate, which intermediate melt flow rate is lower than the final melt flow rate, to obtain the final heterophasic propylene copolymer,
wherein the intermediate heterophasic propylene copolymer (A′) consists of
(a) a propylene-based matrix,
(b) a dispersed ethylene-α-olefin copolymer,
wherein the sum of the total amount of propylene-based matrix and total amount of the dispersed ethylene-α-olefin copolymer in the intermediate heterophasic propylene copolymer is 100 wt % based on the intermediate heterophasic propylene copolymer.

The present invention relates to a polymer composition comprising polycarbonate and acrylonitrile-butadiene-styrene copolymer (ABS), wherein the polymer composition demonstrates improved heat ageing properties and improved surface appearance properties.

Polymer compositions comprising polycarbonate and ABS are well known polymeric materials that find their application in a wide variety of technical fields. ABS is a copolymer of acrylonitrile, butadiene and styrene. A particular area of application where such compositions find their use is in automotive parts, such as injection moulded parts. Because of their suitable balance of properties, both with regard to the quality of the moulded part as well as with regard to the ease and quality of use during the moulding process, polymer compositions comprising polycarbonate and ABS are widely used for such applications.

As a results of amongst others developments in design of automotive parts, it is increasingly desired to be able to produce parts having a particularly large size using such polymer compositions. Such large parts also contain larger surface areas. The polymer compositions comprising polycarbonate and ABS according to the state of the art however are prone to surface defects that occur when moulded into a part having a large surface area via injection moulding.

A particular indicator for the presence of such surface defects is the presence of so-called silver streaks. This phenomenon is discussed in for example US20030047839A1. US20030047839A1 mentions it to be occurring in injection moulding processes of amongst others compositions comprising polycarbonate and ABS, and seek to provide a solution to this issue by using a particular type of injection moulding machine having a defined dimension of the shot volume related to the screw stroke. This process however provides significant disadvantages, a main being the fact that being confined to such particular geometry of the injection moulding machine it requires a particular design for each particular injection moulding process, where in practise it is desired to use a particular screw design of an injection moulding machine in combination with different moulds that may require variation of the shot volume. It is therefore desirable to have access to a polymer composition that demonstrates a reduced tendency to silver streak formation and can be used without being confined to a particular design of the injection moulding machine that is used in the production of injection moulded parts using the polymer composition.

Further, in particular when producing large area or volume articles via injection moulding, the molten polymer composition may, in certain circumstances or process conditions, during the injection moulding process be exposed to a certain long residence time in the melt phase at elevated temperatures, particularly temperatures above the melting point of the thermoplastic components in the polymer composition. Such lengthy exposure can lead to polymer degradation to occur, which may affect the weight average molecular weight of the polymers in the polymer composition, for example of the polycarbonate. It is therefore further also desired to have access to thermoplastic compositions wherein the degradation occurring as a result of exposure to temperatures above the melting temperature is particularly low.

The above clearly presents that there is a desire to obtain polymer compositions comprising polycarbonate and ABS that do provide the desired properties with regard to part quality and processability via injection moulding, but which show an improved quality of the surface area of parts produced via injection moulding.

This has now been achieved according to the present invention by a polymer composition comprising:
polycarbonate;
acrylonitrile-butadiene-styrene copolymer; and
≥0.001 and ≤0.500 wt % of a phosphate salt of zinc, sodium, calcium, potassium or magnesium, with regard to the total weight of the polymer composition.

Such polymer composition demonstrates a reduction of surface defects in the form of silver streaks, whereas further demonstrating a desired balance of mechanical properties, thermal properties and processing properties. Further, such polymer composition demonstrates a particularly low decrease of the weight average molecular weight upon lengthy exposure to temperatures above the melting temperature of the polymer components of the composition, such as a temperature of 300° C. or above.

The polymer composition according to the present invention comprises polycarbonate. Polycarbonate in the context of the present invention may for example relate to polymers or mixtures of polymers comprising polymeric units according to the formula I:

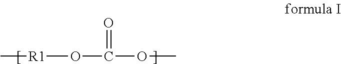

wherein R1 is a moiety comprising at least one aromatic ring. Preferably, at least 60% of the polymeric units in the polycarbonate are units according to formula I. More preferably, at least 80% of the polymeric units in the polycarbonate are units according to formula I. Even more preferably, at least 90%, or at least 95%, or at least 98% of the polymeric units in the polycarbonate are units according to formula I. In a particular embodiment, the polycarbonate is a homopolymer comprising repeating units according to formula I.

In a particular embodiment, R1 is a moiety having a molecular formula R2-R3-R2, wherein each R2 individually is a monocyclic divalent aryl moiety and R3 is a bridging moiety wherein each R2 is bound to the same atom of moiety R3. For example, R3 may be a hydrocarbon moiety, for example a hydrocarbon moiety comprising 1-10 carbon atoms. In a particular embodiment, R3 is a moiety selected from methylene, cyclohexylidene or isopropylidene.

It is particularly preferred that each R2 is phenyl and R3 is isopropylidene.

The polycarbonate that may be used in the polymer composition according to the present invention may for example be produced via interfacial polymerisation processes or via bulk polymerisation processes. The polycarbonate preferably comprises polymeric units comprising moieties derived from 2,2-bis(4-hydroxyphenyl)propane. Preferably, the moieties R1 according to formula I are moieties derived from 2,2-bis(4-hydroxyphenyl)propane.

The polycarbonate may for example have a weight average molecular weight of ≥20000 g/mol, preferably ≥25000 g/mol, more preferably ≥30000 g/mol, more preferably ≥35000 g/mol, more preferably ≥40000 g/mol. The polycarbonate may for example have a molecular weight of ≤100000 g/mol, preferably ≤80000 g/mol, more preferably ≤70000 g/mol, more preferably ≤60000 g/mol. The polycarbonate may for example have a weight average molecular weight of ≥20000 and ≤100000 g/mol, preferably ≥25000 and ≤80000 g/mol, more preferably ≥30000 and ≤80000 g/mol, more preferably ≥35000 and ≤70000 g/mol, more preferably ≥40000 and ≤60000 g/mol. Such polycarbonate provides desirable processing properties combined with desirable properties of the moulded product.

The polycarbonate that is used in the polymer composition according to the present invention is in a particular embodiment a mixture comprising a first polycarbonate and a second polycarbonate. It is preferred that the first polycarbonate has a different weight average molecular weight than the second polycarbonate. It is preferred that the first polycarbonate has a lower weight average molecular weight than the second polycarbonate. This first polycarbonate may for example have a weight average molecular weight of ≥20000 and <50000 g/mol, preferably ≥30000 and ≤45000 g/mol, more preferably ≥35000 and ≤42000 g/mol. The second polycarbonate may for example have a weight average molecular weight of ≥50000 g/mol and ≤100000 g/mol, preferably ≥50000 and ≤80000 g/mol, more preferably ≥52000 and ≤60000 g/mol. It is particularly preferred that the polycarbonate is a mixture comprising a first polycarbonate and a second polycarbonate, wherein the first polycarbonate has a weight average molecular weight of ≥20000 and <50000 g/mol and wherein the second polycarbonate has a weight average molecular weight of ≥50000 g/mol and ≤100000 g/mol. It is further is particularly preferred that the polycarbonate is a mixture comprising a first polycarbonate and a second polycarbonate, wherein the first polycarbonate has a weight average molecular weight of ≥30000 and <45000 g/mol and wherein the second polycarbonate has a weight average molecular weight of ≥50000 g/mol and ≤70000 g/mol. Alternatively, the polycarbonate may be a mixture comprising a first polycarbonate and a second polycarbonate, the first polycarbonate having a weight average molecular weight of less than 45000 g/mol, and second polycarbonate having a weight average molecular weight of at least 50000 g/mol.

The weight average molecular weight M_{w} may for example be determined using size-exclusion chromatography using polycarbonate standards, such as for example via the method of ISO 16014-1 (2012).

It is preferred that the polymer composition according to the present invention comprises ≥30.0 wt % of polycarbonate, more preferably ≤40.0 wt %, more preferably ≥50.0 wt %, more preferably ≥60.0 wt %, more preferably ≥70.0 wt %, with regard to the total weight of the polymer composition. It is preferred that the polymer composition comprises ≤95.0 wt % of polycarbonate, more preferably ≤90.0 wt %, more preferably ≤85.0 wt %, more preferably ≤80.0 wt %, with regard to the total weight of the polymer composition.

It is particularly preferred that the polymer composition comprises ≥30.0 wt % and ≤95.0 wt % of polycarbonate, more preferably ≥50.0 wt % and ≤90.0 wt %, more preferably ≥60.0 wt % and ≤85.0 wt %, with regard to the total weight of the polymer composition.

In the embodiment of the invention where the polycarbonate is a mixture of a first polycarbonate and a second polycarbonate, the polymer composition comprises ≥10.0 wt % of the first polycarbonate and ≥10.0 wt % of the second polycarbonate, with regard to the total weight of the polymer composition. More preferably, the polymer composition comprises ≥20.0 wt % of the first polycarbonate and ≥20.0 wt % of the second polycarbonate, with regard to the total weight of the polymer composition. Even more preferably, the polymer composition comprises ≥30.0 wt % of the first polycarbonate and ≥30 wt % of the second polycarbonate, with regard to the total weight of the polymer composition.

Preferably, the polymer composition comprises ≤45.0 wt % of the first polycarbonate and ≤45.0 wt % of the second polycarbonate, with regard to the total weight of the polymer composition. More preferably, the polymer composition comprises ≤40.0 wt % of the first polycarbonate and ≤40.0 wt % of the second polycarbonate, with regard to the total weight of the polymer composition.

Particularly preferably, the polymer composition comprises ≥10.0 and ≤45.0 wt % of the first polycarbonate, and ≥10.0 and ≤45.0 wt % of the second polycarbonate, with regard to the total weight of the polymer composition. More preferably, the polymer composition comprises ≥30.0 and ≤40.0 wt % of the first polycarbonate, and ≥30.0 and ≤40.0 wt % of the second polycarbonate, with regard to the total weight of the polymer composition.

Further particularly preferably, the polymer composition comprises ≥10.0 and ≤45.0 wt % of the first polycarbonate, and ≥10.0 and ≤45.0 wt % of the second polycarbonate, with regard to the total weight of the polymer composition, wherein the first polycarbonate has a weight average molecular weight of ≥20000 and <50000 g/mol and wherein the second polycarbonate has a weight average molecular weight of ≥50000 g/mol and ≤100000 g/mol. More preferably, the polymer composition comprises ≥30.0 and ≤40.0 wt % of the first polycarbonate, and ≥30.0 and ≤40.0 wt % of the second polycarbonate, with regard to the total weight of the polymer composition, wherein the first polycarbonate has a weight average molecular weight of ≥30000 and <45000 g/mol and wherein the second polycarbonate has a weight average molecular weight of ≥50000 g/mol and ≤70000 g/mol.

It is particularly preferred that where the polycarbonate is a mixture of a first polycarbonate and a second polycarbonate, one of the first polycarbonate and the second polycarbonate is produced via interfacial polymerisation. It is further particularly preferred that where the polycarbonate is a mixture of a first polycarbonate and a second polycarbonate, one of the first polycarbonate and the second polycarbonate is produced via melt polymerisation. It is particularly preferred that where the polycarbonate is a mixture of a first polycarbonate and a second polycarbonate, one of the first polycarbonate and the second polycarbonate is produced via interfacial polymerisation and the other of the first polycarbonate and the second polycarbonate is produced via melt polymerisation.

Even further particularly, it is preferred that where the polycarbonate is a mixture of a first polycarbonate and a second polycarbonate, the first polycarbonate has a lower weight average molecular weight than the second polycarbonate, and the first polycarbonate is produced via interfacial polymerisation. It is also particularly preferred that where the polycarbonate is a mixture of a first polycarbonate and a second polycarbonate, the first polycarbonate has a lower weight average molecular weight than the second polycarbonate, and the second polycarbonate is produced via melt polymerisation. It is even further particularly preferred that where the polycarbonate is a mixture of a first polycarbonate and a second polycarbonate, the first polycarbonate has a lower molecular weight than the second polycarbonate, the first polycarbonate is produced via interfacial polymerisation, and the second polycarbonate is produced via melt polymerisation.

In particular, where the polycarbonate is a mixture of a first polycarbonate and a second polycarbonate, it is preferred that the first polycarbonate is produced via interfacial polymerisation and the second polycarbonate is produced via melt polymerisation, wherein the polymer composition comprises ≥10.0 and ≤45.0 wt % of the first polycarbonate, and ≥10.0 and ≤45.0 wt % of the second polycarbonate, with regard to the total weight of the polymer composition. Further particularly, where the polycarbonate is a mixture of a first polycarbonate and a second polycarbonate, it is preferred that the first polycarbonate is produced via interfacial polymerisation and the second polycarbonate is produced via melt polymerisation, wherein the polymer composition comprises ≥30.0 and ≤40.0 wt % of the first polycarbonate, and ≥30.0 and ≤40.0 wt % of the second polycarbonate, with regard to the total weight of the polymer composition.

Even further particularly, where the polycarbonate is a mixture of a first polycarbonate and a second polycarbonate, it is preferred that the first polycarbonate is produced via interfacial polymerisation and the second polycarbonate is produced via melt polymerisation, wherein the polymer composition comprises ≥10.0 and ≤45.0 wt % of the first polycarbonate, and ≥10.0 and ≤45.0 wt % of the second polycarbonate, with regard to the total weight of the polymer composition, the first polycarbonate has a weight average molecular weight of ≥20000 and <50000 g/mol and wherein the second polycarbonate has a weight average molecular weight of ≥50000 g/mol and ≤100000 g/mol. More further particularly, where the polycarbonate is a mixture of a first polycarbonate and a second polycarbonate, it is preferred that the first polycarbonate is produced via interfacial polymerisation and the second polycarbonate is produced via melt polymerisation, wherein the polymer composition comprises ≥30.0 and ≤40.0 wt % of the first polycarbonate, and ≥30.0 and ≤40.0 wt % of the second polycarbonate, with regard to the total weight of the polymer composition, the first polycarbonate has a weight average molecular weight of ≥30000 and <45000 g/mol and wherein the second polycarbonate has a weight average molecular weight of ≥50000 g/mol and ≤70000 g/mol.

The polymer composition according to the present invention comprises acrylonitrile-butadiene-styrene copolymer. The acrylonitrile-butadiene-styrene copolymer is also referred to as ABS.

The polymer composition according to the present invention may for example comprise ≥5.0 wt %, preferably ≥10.0 wt %, more preferably ≥15.0 wt %, or even more preferably ≥20.0 wt % of the acrylonitrile-butadiene-styrene copolymer, with regard to the total weight of the polymer composition.

The polymer composition according to the present invention may for example comprise ≤80.0 wt %, preferably ≤60.0 wt %, more preferably ≤50.0 wt %, or even more preferably ≤40.0 wt % of the acrylonitrile-butadiene-styrene copolymer, with regard to the total weight of the polymer composition.

Preferably, the polymer composition according to the present invention comprises ≥5.0 and ≤80.0 wt %, preferably ≥10.0 and ≤60.0 wt %, more preferably ≥20.0 and ≤40.0 wt % of the acrylonitrile-butadiene-styrene copolymer, with regard to the total weight of the polymer composition.

The ABS may for example be a copolymer comprising polymeric units comprising moieties derived from acrylonitrile, moieties derived from 1,3-butadiene and moieties derived from styrene. The ABS may for example be a copolymer comprising ≥10.0 wt % and ≤70.0 wt % of moieties derived from 1,3-butadiene, with regard to the total weight of the ABS. Preferably, ABS may is a copolymer comprising ≥20.0 wt % and ≤60.0 wt %, more preferably ≥30.0 wt % and ≤50.0 wt % of moieties derived from 1,3-butadiene, with regard to the total weight of the ABS.

In a particular embodiment, the ABS comprises a mixture of a first copolymer and a second copolymer. The first copolymer may be a copolymer comprising polymeric units comprising moieties derived from acrylonitrile, moieties derived from 1,3-butadiene and moieties derived from styrene. The second copolymer may be a copolymer comprising polymeric units comprising moieties derived from acrylonitrile and moieties derived from styrene.

In the embodiment of the invention where the ABS is a mixture comprising a first copolymer and a second copolymer, where first copolymer is a copolymer comprising polymeric units comprising moieties derived from acrylonitrile, moieties derived from 1,3-butadiene and moieties derived from styrene and the second copolymer is a copolymer comprising polymeric units comprising moieties derived from acrylonitrile and moieties derived from styrene, it is preferred that the first copolymer comprises ≥40.0 wt % and ≤70.0 wt %, more preferably ≥40.0 and ≤60.0 wt %, of moieties derived from 1,3-butadiene, with regard to the total weight of the first copolymer.

In a particular embodiment of the invention, the ABS is a mixture comprising a first copolymer and a second copolymer, wherein the first copolymer comprises moieties derived from acrylonitrile, moieties derived from 1,3-butadiene and moieties derived from styrene, and the second copolymer comprises polymeric units comprising moieties derived from acrylonitrile and moieties derived from styrene.

Preferably, the ABS is a mixture comprising a first copolymer and a second copolymer, wherein the first copolymer comprises moieties derived from acrylonitrile, moieties derived from 1,3-butadiene and moieties derived from styrene, and the second copolymer comprises polymeric units comprising moieties derived from acrylonitrile and moieties derived from styrene, wherein the second copolymer does not comprise moieties derived from 1,3-butadiene.

More preferably, the ABS is a mixture comprising a first copolymer and a second copolymer, wherein the first copolymer comprises moieties derived from acrylonitrile, moieties derived from 1,3-butadiene and moieties derived from styrene, and the second copolymer consists of polymeric units comprising moieties derived from acrylonitrile and moieties derived from styrene.

Further preferably, the ABS is a mixture comprising a first copolymer and a second copolymer, wherein the first copolymer comprises moieties derived from acrylonitrile, moieties derived from 1,3-butadiene and moieties derived from styrene, and the second copolymer comprises polymeric units comprising moieties derived from acrylonitrile and moieties derived from styrene, wherein the polymer composition comprises ≤15.0 wt % of the second copolymer, with regard to the total weight of the polymer composition. Even more preferably, the ABS is a mixture comprising a first copolymer and a second copolymer, wherein the first copolymer comprises moieties derived from acrylonitrile, moieties derived from 1,3-butadiene and moieties derived from styrene, and the second copolymer comprises polymeric units comprising moieties derived from acrylonitrile and moieties derived from styrene, wherein the polymer composition comprises ≤15.0 wt % of the first copolymer and ≤15.0 wt % of the second copolymer, with regard to the total weight of the polymer composition.

The polymer composition according the invention may for example comprise:
≥50.0 and ≤95.0 wt % of the polycarbonate;
≥5.0 and ≤80.0 wt % of the acrylonitrile-butadiene-styrene copolymer with regard to the total weight of the polymer composition.

The polymer composition according to the present invention comprises ≥0.001 and ≤0.500 wt % of a phosphate salt of zinc, sodium, calcium, potassium or magnesium, with regard to the total weight of the polymer composition. The phosphate salt may be a monobasic phosphate salt, a dibasic phosphate salt or a tribasic phosphate salt. The phosphate salt may be a compound selected from monobasic zinc phosphate, dibasic zinc phosphate, tribasic zinc phosphate, monobasic calcium phosphate, dibasic calcium phosphate, tribasic calcium phosphate, monobasic magnesium phosphate, dibasic magnesium phosphate, tribasic magnesium phosphate, monobasic sodium phosphate, dibasic sodium phosphate, tribasic sodium phosphate, monobasic potassium phosphate, dibasic potassium phosphate, tribasic potassium phosphate, or combinations thereof.

It is preferred that the phosphate salt is a compound selected from monobasic zinc phosphate, dibasic zinc phosphate, tribasic zinc phosphate, monobasic calcium phosphate, dibasic calcium phosphate, tribasic calcium phosphate, monobasic magnesium phosphate, dibasic magnesium phosphate, tribasic magnesium phosphate, or combinations thereof.

It is particularly preferred that the phosphate salt is a compound selected from monobasic zinc phosphate, dibasic zinc phosphate, tribasic zinc phosphate, or combinations thereof.

It is even more particularly preferred that the phosphate salt is monobasic zinc phosphate.

The polymer composition according to the invention in a preferred embodiment comprises ≥0.001 and ≤0.400 wt % of the phosphate salt, more preferably ≥0.002 and ≤0.300 wt %, even more preferably ≥0.005 and ≤0.200 wt %, even more preferably ≥0.010 and ≤0.100 wt %, with regard to the total weight of the polymer composition. It is particularly preferred that the polymer composition comprises ≥0.001 and ≤0.400 wt % of the phosphate salt, more preferably ≥0.002 and ≤0.300 wt %, even more preferably ≥0.005 and ≤0.200 wt %, even more preferably ≥0.010 and ≤0.100 wt %, with regard to the total weight of the polymer composition, wherein the phosphate salt is a monobasic phosphate salt, a dibasic phosphate salt or a tribasic phosphate salt.

More particularly, it is preferred that the polymer composition comprises ≥0.001 and ≤0.400 wt % of the phosphate salt, more preferably ≥0.002 and ≤0.300 wt %, even more preferably ≥0.005 and ≤0.200 wt %, even more preferably ≥0.010 and ≤0.100 wt %, with regard to the total weight of the polymer composition, wherein the phosphate salt is a compound selected from monobasic zinc phosphate, dibasic zinc phosphate, tribasic zinc phosphate, monobasic calcium phosphate, dibasic calcium phosphate, tribasic calcium phosphate, monobasic magnesium phosphate, dibasic magnesium phosphate, tribasic magnesium phosphate, monobasic sodium phosphate, dibasic sodium phosphate, tribasic sodium phosphate, monobasic potassium phosphate, dibasic potassium phosphate, tribasic potassium phosphate, or combinations thereof. Even more particularly, it is preferred that the polymer composition comprises ≥0.001 and ≤0.400 wt % of the phosphate salt, more preferably ≥0.002 and ≤0.300 wt %, even more preferably ≥0.005 and ≤0.200 wt %, even more preferably ≥0.010 and ≤0.100 wt %, with regard to the total weight of the polymer composition, wherein the phosphate salt is a compound selected from monobasic zinc phosphate, dibasic zinc phosphate, tribasic zinc phosphate, monobasic calcium phosphate, dibasic calcium phosphate, tribasic calcium phosphate, monobasic magnesium phosphate, dibasic magnesium phosphate, tribasic magnesium phosphate, or combinations thereof. Even more particularly, it is preferred that the polymer composition comprises ≥0.001 and ≤0.400 wt % of the phosphate salt, more preferably ≥0.002 and ≤0.300 wt %, even more preferably ≥0.005 and ≤0.200 wt %, even more preferably ≥0.010 and ≤0.100 wt %, with regard to the total weight of the polymer composition, wherein the phosphate salt is a compound selected from monobasic zinc phosphate, dibasic zinc phosphate, tribasic zinc phosphate, or combinations thereof. Further particularly, it is preferred that that the polymer composition comprises ≥0.005 and ≤0.200 wt %, of the phosphate salt, more preferably ≥0.010 and ≤0.100 wt %, with regard to the total weight of the polymer composition, wherein the phosphate salt is a compound selected from monobasic zinc phosphate, dibasic zinc phosphate, tribasic zinc phosphate, or combinations thereof. Even further particularly, it is preferred that that the polymer composition comprises ≥0.005 and ≤0.200 wt %, of the phosphate salt, more preferably ≥0.010 and ≤0.100 wt %, with regard to the total weight of the polymer composition, wherein the phosphate salt is monobasic zinc phosphate.

Particularly, it is preferred that the polymer composition comprises ≥0.010 and ≤0.100 wt %, with regard to the total weight of the polymer composition of a phosphate being a monobasic phosphate salt of zinc, sodium, calcium, potassium or magnesium, preferably zinc, wherein the monobasic phosphate salt accounts for >90.0 wt %, preferably >95.0 wt % of the total of phosphate salts present in the polymer composition.

A further embodiment of the present invention relates to a polymer composition comprising:
polycarbonate;
acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate has a weight average molecular weight of ≥35000 and ≤70000 g/mol as determined in accordance with the method of ISO 16014-1 (2012).

In yet a further embodiment, the present invention relates to a polymer composition comprising:
≥50.0 and ≤95.0 wt % polycarbonate;
≥5.0 and ≤80.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate has a weight average molecular weight of ≥35000 and ≤70000 g/mol as determined in accordance with the method of ISO 16014-1 (2012).

In a further particularly preferred embodiment, the present invention also relates to a polymer composition comprising:
≥50.0 and ≤95.0 wt % polycarbonate;
≥5.0 and ≤80.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate has a weight average molecular weight of ≥35000 and ≤70000 g/mol as determined in accordance with the method of ISO 16014-1 (2012); and wherein the phosphate salt is monobasic zinc phosphate.

Further, a particular embodiment of the invention relates to a polymer composition comprising:
polycarbonate;
acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate is a mixture comprising a first polycarbonate and a second polycarbonate, the first polycarbonate has a weight average molecular weight of ≥30000 and <45000 g/mol and the second polycarbonate has a weight average molecular weight of ≥50000 g/mol and ≤70000 g/mol.

More particularly, the present invention also relates in one of its embodiments to a polymer composition comprising:
≥50.0 and ≤95.0 wt % polycarbonate;
≥5.0 and ≤80.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate is a mixture comprising a first polycarbonate and a second polycarbonate, the first polycarbonate has a weight average molecular weight of ≤30000 and <45000 g/mol and the second polycarbonate has a weight average molecular weight of ≥50000 g/mol and ≤70000 g/mol.

Further more particularly, the present invention relates in yet another embodiment to a polymer composition comprising:
≥50.0 and ≤95.0 wt % polycarbonate;
≥5.0 and ≤80.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition;

wherein the polycarbonate is a mixture comprising a first polycarbonate and a second polycarbonate, the first polycarbonate has a weight average molecular weight of ≥30000 and <45000 g/mol and the second polycarbonate has a weight average molecular weight of ≥50000 g/mol and ≤70000 g/mol, and wherein the phosphate salt is monobasic zinc phosphate.

In another particular embodiment, the polymer composition comprises
polycarbonate;
≥20.0 and ≤40.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition.

Also, an embodiment of the invention relates to a polymer composition comprising:
≥50.0 wt % polycarbonate;
≥20.0 and ≤45.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition.

More particularly, the invention relates to a polymer composition comprising:
≥50.0 wt % polycarbonate;
≥20.0 and ≤45.0 wt % acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the phosphate salt is monobasic zinc phosphate.

In a particularly desired embodiment, the invention relates to a polymer composition comprising
polycarbonate;
≥20.0 and ≤40.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition.

Also, an embodiment of the invention relates to a polymer composition comprising:
≥50.0 wt % polycarbonate;
≥20.0 and ≤45.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition.

More particularly, the invention relates to a polymer composition comprising:
≥50.0 wt % polycarbonate;
≥20.0 and ≤45.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the phosphate salt is monobasic zinc phosphate.

In a further particularly desired embodiment, the invention relates to a polymer composition comprising
polycarbonate;
≥20.0 and ≤40.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate may has a weight average molecular weight of ≥35000 and ≤70000 g/mol as determined in accordance with the method of ISO 16014-1 (2012).

Also, an embodiment of the invention relates to a polymer composition comprising:
≥50.0 wt % polycarbonate;
≥20.0 and ≤45.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the polycarbonate has a weight average molecular weight of ≥35000 and ≤70000 g/mol as determined in accordance with the method of ISO 16014-1 (2012).

More particularly, the invention relates to a polymer composition comprising:
≥50.0 wt % polycarbonate;
≥20.0 and ≤45.0 wt % acrylonitrile-butadiene-styrene copolymer comprising ≥20.0 wt % and ≤60.0 wt %, of moieties derived from 1,3-butadiene, with regard to the total weight of the acrylonitrile-butadiene-styrene copolymer; and
≥0.001 and ≤0.500 wt % of a phosphate salt of zinc, sodium, calcium, potassium or magnesium, with regard to the total weight of the polymer composition;
wherein the phosphate salt is monobasic zinc phosphate; and wherein the polycarbonate has a weight average molecular weight of ≥35000 and ≤70000 g/mol as determined in accordance with the method of ISO 16014-1 (2012).

Further preferably, the invention relates to a polymer composition comprising:
≥70.0 wt % polycarbonate;
≥15.0 and ≤30.0 wt % acrylonitrile-butadiene-styrene copolymer being a mixture comprising a first copolymer and a second copolymer, wherein the first copolymer comprises moieties derived from acrylonitrile, moieties derived from 1,3-butadiene and moieties derived from styrene, and the second copolymer consists of polymeric units comprising moieties derived from acrylonitrile and moieties derived from styrene; and
≥0.010 and ≤0.100 wt % of a phosphate salt being a monobasic phosphate salt of zinc, sodium, calcium, potassium or magnesium with regard to the total weight of the polymer composition.

In a particularly preferred embodiment, the invention relates to a polymer composition comprising:
≥70.0 wt % polycarbonate;
≥15.0 and ≤30.0 wt % acrylonitrile-butadiene-styrene copolymer being a mixture comprising a first copolymer and a second copolymer, wherein the first copolymer comprises moieties derived from acrylonitrile, moieties derived from 1,3-butadiene and moieties derived from styrene, and the second copolymer consists of polymeric units comprising moieties derived from acrylonitrile and moieties derived from styrene; and
≥0.010 and ≤0.100 wt % of a phosphate salt being a monobasic phosphate salt of zinc, sodium, calcium, potassium or magnesium with regard to the total weight of the polymer composition wherein the monobasic phosphate salt accounts for >90.0 wt % of the total of phosphate salts present in the polymer composition.

Even further particularly preferred is an embodiment wherein the invention relates to a polymer composition comprising:
≥70.0 wt % polycarbonate;
≥15.0 and ≤30.0 wt % acrylonitrile-butadiene-styrene copolymer being a mixture comprising a first copolymer and a second copolymer, wherein the first copolymer comprises moieties derived from acrylonitrile, moieties derived from 1,3-butadiene and moieties derived from styrene, and the second copolymer consists of polymeric units comprising moieties derived from acrylonitrile and moieties derived from styrene, wherein the polymer composition comprises ≤15.0 wt % of the first copolymer and ≤15.0 wt % of the second copolymer, with regard to the total weight of the polymer composition; and
≥0.010 and ≤0.100 wt % of a phosphate salt being a monobasic phosphate salt of zinc, sodium, calcium, potassium or magnesium with regard to the total weight of the polymer composition wherein the monobasic phosphate salt accounts for >90.0 wt % of the total of phosphate salts present in the polymer composition.

Also particularly preferred is an embodiment wherein the invention relates to a polymer composition comprising:
≥70.0 wt % polycarbonate;
≥15.0 and ≤30.0 wt % acrylonitrile-butadiene-styrene copolymer being a mixture comprising a first copolymer and a second copolymer, wherein the first copolymer comprises moieties derived from acrylonitrile, moieties derived from 1,3-butadiene and moieties derived from styrene, and the second copolymer consists of polymeric units comprising moieties derived from acrylonitrile and moieties derived from styrene, wherein the polymer composition comprises ≤15.0 wt % of the first copolymer and ≤15.0 wt % of the second copolymer, with regard to the total weight of the polymer composition; and
≥0.010 and ≤0.100 wt % of a phosphate salt being a monobasic phosphate salt of zinc, sodium, calcium, potassium or magnesium wherein the monobasic phosphate salt is the only phosphate salt present in the polymer composition.

The invention also relates to an injection moulded article produced using the polymer composition according to the present invention.

The invention will now be illustrated by the following non-limiting examples.

For the experiments that were performed to demonstrate the present invention, the materials as listed in table I below were used.

TABLE I
Materials

| | |
|---|---|
| PC1 | Lexan ML5221-111N, a bisphenol-A based polycarbonate |
| | produced via interfacial polymerisation, having M_{w} |
| | of about 41000 g/mol, obtainable from SABIC |
| PC2 | Lexan 102L-11204, a bisphenol-A based polycarbonate |
| | produced via melt polymerisation, having M_{w} of about |
| | 55000 g/mol, obtainable from SABIC |
| ABS | ABS HR181, an acrylonitrile-butadiene-styrene copolymer |
| | produced via emulsion polymerisation, comprising |
| | 50.0 wt % of units derived from butadiene, obtainable |
| | from Kumho |
| SAN | SAN INP581, an acrylonitrile-styrene copolymer produced |
| | via mass polymerisation, obtainable from SABIC |
| PETS | Pentaerythritol tetrastearate, CAS reg. no. 115-83-3, |
| | obtainable from FACI |
| AO | Irganox 1076, CAS reg. no. 2082-79-3, obtainable |
| | from BASF |
| PH | Irgafos 168, Tris(2,4-di-tert-butylphenyl)phosphite, |
| | CAS reg. no. 31570-04-4, obtainable from BASF |
| MZP | Z 21-82, Monobasic zinc phosphate, CAS reg. no. |
| | 13598-37-3, obtainable from Budenheim |
| PA | Phosphorous acid 45%, CAS reg. no. 10294-56-1, |
| | obtainable from Sinopharm |
| CB | M800, a carbon black, CAS reg. no. 1333-86-4, |
| | obtainable from Cabot |

Using the above listed materials, a number of polymer compositions were prepared via melt compounding according to the formulations as presented in table II below. The melt compounding was performed in a Toshiba twin screw extruder having a screw length of 1517 mm, at a barrel temperature of 260° C., a screw speed of 400 rpm and a throughput of 60 kg/h. Formulations 1 and 2 present polymer compositions according to the present invention. Formulations 3-6 present comparative examples.

TABLE II
Formulations of polymer compositions

| | 1 | 2 | 3 | 4 | 5 | 6 |
|---|---|---|---|---|---|---|
| PC1 | 36.24 | 36.24 | 36.24 | 36.24 | 36.24 | 36.24 |
| PC2 | 37.00 | 37.00 | 37.00 | 37.00 | 37.00 | 37.00 |
| ABS | 11.40 | 11.40 | 11.40 | 11.40 | 11.40 | 11.40 |
| SAN | 14.40 | 14.40 | 14.40 | 14.40 | 14.40 | 14.40 |
| PETS | 0.30 | 0.30 | 0.30 | 0.30 | 0.30 | 0.30 |
| AO | 0.08 | 0.08 | 0.08 | 0.08 | 0.08 | 0.08 |
| PH | 0.08 | 0.08 | 0.08 | 0.08 | 0.08 | 0.10 |
| MZP | 0.005 | 0.05 | | | | |
| PA | | | 0.05 | 0.10 | | |
| CB | 0.50 | 0.50 | 0.50 | 0.50 | 0.50 | 0.50 |

The quantities as presented in table II represent parts by weight.

Of each of the polymer compositions that were prepared, various properties including materials properties, processing properties and surface appearance properties were determined as presented in table III.

TABLE III
Properties of experimental polymer compositions.

| | 1 | 2 | 3 | 4 | 5 | 6 |
|---|---|---|---|---|---|---|
| MFR | 20.1 | 21.2 | 21.0 | 21.8 | 21.3 | 22.6 |
| Izod 23 | 699 | 702 | 696 | 682 | 705 | 703 |
| Izod −30 | 550 | 550 | 544 | 546 | 566 | 571 |
| TM | 2300 | 2313 | 2329 | 2262 | 2305 | 2295 |
| HDT | 114 | 115 | 116 | 115 | 113 | 114 |
| PC ΔM_{w} | 11.7 | 6.5 | 10.0 | 11.8 | 16.0 | 13.0 |
| SSR | 25 | 50 | −100 | −120 | 0 | 10 |

Wherein:
MFR is the melt mass flow rate as determined in accordance with ASTM D1238 (2013), at a temperature of 260° C. and a loading of 5.00 kg, expressed in g/10 min. The MFR may be considered an indicator for the processability of the polymer composition. A higher melt mass flow rate indicates a less viscous and thus better flowing polymer composition.
Izod 23 is the notched Izod impact strength as determined in accordance with ASTM D256 (2010) at 23° C., expressed in J/m.
Izod −30 is the notched Izod impact strength as determined in accordance with ASTM D256 (2010) at −30° C., expressed in J/m.
TM is the tensile modulus as determined in accordance with ASTM D638 (2014), expressed in MPA.
HDT is the heat deflection temperature as determined in accordance with ASTM D648 (2016) using samples of 6.4 mm under a load of 1.82 MPa, expressed in ° C.
PC ΔM_{w} is the reduction of the molecular weight M_{w} of the polycarbonate in the polymer composition after subjecting the polymer composition to abusive moulding conditions by exposure for a period of 20 min to a temperature of 300° C. in a moulding machine. The M_{w} of the polycarbonate was determined on the polymer composition as prepared by melt compounding (M_{w}1) and on the polymer composition obtained after subjecting the polymer composition to the abusive conditions (M_{w}2). The M_{w} was determined via size-exclusion chromatography using polycarbonate standards, via the method of ISO 16014-1 (2012). ΔM_{w} is expressed in % and was calculated as:

$$Δ {M}_{w} = \frac{{M}_{w} 1 - {M}_{w} 2}{{M}_{w} 1} * 100 \%$$

SSR is the reduction of silver streaks on the surface of moulded plaques compared to a standard, expressed in %. For determination of the silver streak reduction, composition 5 was taken as standard; it represent the polymer composition without any measures taken to improve the surface properties in term of silver streaks. For determination of the quantity of silver streaks, a quantity of material of each of the polymer compositions was subjected to a dwell time in an injection moulding machine of 20 min at 300° C., upon which plaques were moulded having a length of 90 mm, a width of 60 mm and a thickness of 2.0 mm. By visual inspection, the quantity of silver streaks on each plaque was determined. The reduction of silver streaks SSR for each of the polymer compositions was determined via:

$${SSR}_{n} = \frac{{SS}_{n} - {SS}_{5}}{{SS}_{5}} * 100 \%$$

Wherein
   SSRₙ=the silver streak reduction for a given polymer composition n;
   SSₙ=the number of silver streaks observed on sample plaques of polymer composition n; and
   SS₅=the number of silver streaks observed on sample plaques of polymer composition 5.
A positive SSR indicates a reduction of silver streaks; a negative SSR indicates an increase of silver streaks.

The above examples show that the polymer composition according to the present invention demonstrates desirable materials properties, as indicated by the Izod impact strength and the tensile modulus, desirable thermal properties as indicated by the heat deflection temperature, desirable processing properties as indicated by the melt mass flow rate, and provide an unexpected reduction of the quantities of sliver streaks. It is further demonstrated by polymer composition 2 that incorporation of a quantity of ≥0.02 and ≤0.10 wt % of zinc phosphate provides a particular reduction of the quantity of silver streaks combined with a particular low reduction of the molecular weight of the polycarbonate after abusive moulding.

1. A process for the preparation of a final heterophasic propylene copolymer (A) having a final melt flow rate in the range from 65 to 110 dg/min as measured according to ISO1133 at 230° C. and 2.16 kg, comprising:
visbreaking an intermediate heterophasic propylene copolymer (A′) having an intermediate melt flow rate, which intermediate melt flow rate is lower than the final melt flow rate, to obtain the final heterophasic propylene copolymer,
wherein the intermediate heterophasic propylene copolymer (A′) consists of
(a) a propylene-based matrix, wherein the propylene-based matrix consists of a propylene homopolymer, wherein the melt flow rate of the propylene-based matrix is in the range from 75 to 85 dg/min as measured according to ISO1133 at 230° C. and 2.16 kg,
(b) a dispersed ethylene-α-olefin copolymer,
wherein the amount of ethylene incorporated into the ethylene-α-olefin copolymer is in the range from 45 to 55 wt % based on the ethylene-α-olefin copolymer,
wherein the amount of ethylene-α-olefin copolymer is less than 15 wt % and at least 10 wt % based on the intermediate heterophasic propylene copolymer,
wherein the melt flow rate of the ethylene-α-olefin copolymer is in the range from 0.50 to 2.0 dg/min as calculated using the following formula:
$$MFREPR = 10 \hat{} ( \frac{Log MFR heterophasic - matrix content * Log MFR PP}{rubber content} )$$
wherein MFR heterophasic is the melt flow rate of the intermediate heterophasic propylene copolymer measured according to ISO1133 (2.16 kg/230° C.),
MFR PP is the MFR of the propylene-based matrix of the intermediate heterophasic propylene copolymer measured according to IS01133 (2.16 kg/230° C.),
matrix content is the amount of the propylene-based matrix in the intermediate heterophasic propylene copolymer, and
rubber content is the amount of the dispersed ethylene-α-olefin copolymer in the intermediate heterophasic propylene copolymer,
wherein the sum of the total amount of propylene-based matrix and total amount of the dispersed ethylene-α-olefin copolymer in the intermediate heterophasic propylene copolymer is 100 wt % based on the intermediate heterophasic propylene copolymer.

2. The process according to claim 1, wherein the intermediate heterophasic propylene copolymer is prepared using a phthalate-free catalyst, wherein the phthalate-free catalyst has a phthalate content of less than for example 150 ppm, based on the total weight of the catalyst.

3. The process according to claim 1, wherein the intermediate heterophasic propylene copolymer is prepared from propylene, ethylene and optionally another α-olefin by contacting propylene, ethylene and optionally another α-olefin in the presence of a catalyst composition to obtain the intermediate heterophasic propylene copolymer,
wherein said catalyst composition is prepared by combined a procatalyst with a co-catalyst and optionally at least one external donor to form the catalyst composition,
wherein the procatalyst is prepared by a process comprising the steps of providing a magnesium-based support, contacting said magnesium-based support with a Ziegler-Natta type catalytic species, an internal donor, and an activator, to yield a procatalyst, wherein the activator is a benzamide according to formula X: 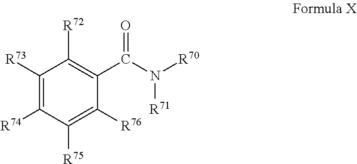
wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, and one or more combinations thereof; and wherein the internal donor is selected from the group consisting of 1,3-diethers represented by the Formula VII, 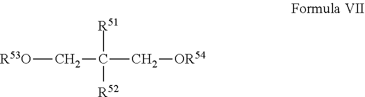
wherein R⁵¹ and R⁵² are each independently selected from a hydrogen or a hydrocarbyl group selected from alkyl, alkenyl, aryl, aralkyl, alkoxycarbonyl or alkylaryl groups, and one or more combinations thereof, and wherein R⁵³ and R⁵⁴ are each independently selected from a hydrocarbyl group.

4. The process according to claim 1, wherein the α-olefin in the ethylene-α-olefin copolymer is propylene.

5. The process according to claim 1, the propylene-based matrix of the intermediate heterophasic propylene copolymer has a molecular weight distribution (M_{w}/Mₙ) in the range from 4.0 to 5.5, wherein Mw stands for the weight average molecular weight and Mn stands for the number average molecular weight are measured by SEC analysis.

6. The process according to claim 1, wherein the final heterophasic propylene copolymer shows an emission of less than 1800 mg/kg, as determined by isopropanol extraction and analysis of the extract using PTV-GC-MS.

7. The process according to claim 1, wherein the shifting ratio, which is the ratio of the final melt flow rate to the intermediate melt flow rate is in the range from 1.3 to 2.5.

8. A heterophasic propylene copolymer (A) obtained by the process of claim 1.

9. The heterophasic propylene copolymer according to claim 8, wherein the impact strength of the final heterophasic propylene copolymer (A) is at least 3.5 kJ/m² as determined at 23° C. according to ISO 180 4A.

10. A composition comprising the heterophasic propylene copolymer (A) of claim 8.

11. The composition according to claim 10, further comprising a nucleating composition (B), wherein (B) the nucleating composition comprises
(i) a first nucleating agent, which comprises a cyclic dicarboxylate salt compound; and
(ii) a second nucleating agent, which comprises talc,
wherein the cyclic dicarboxylate salt compound has the formula (I):

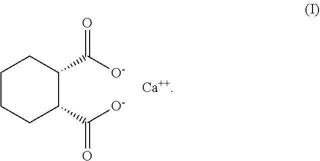

12. The composition according to claim 11, having a flexural modulus of at least 1600 MPa, as determined at 23° C. in parallel and/or perpendicular direction, according to ASTM D790 Procedure B on a sample of 65×12.7×3.2 mm.

13. An article comprising the heterophasic propylene copolymer of claim.

14. The article according to claim 13, wherein the article is an injection molded article.

15. The process according to claim 1, wherein R⁵³ and R⁵⁴ are each independently selected from alkyl, alkenyl, aryl, aralkyl, alkoxycarbonyl or alkylaryl groups, and one or more combinations thereof.

16. The process according to claim 6, wherein the final heterophasic propylene copolymer shows an emission of less than 1700 mg/kg heterophasic propylene copolymer as determined by isopropanol extraction and analysis of the extract using PTV-GC-MS.

17. The process according to claim 1,
wherein the intermediate heterophasic propylene copolymer is prepared using a phthalate-free catalyst, wherein the phthalate-free catalyst has a phthalate content of less than 100 ppm, based on the total weight of the catalyst;
the propylene-based matrix of the intermediate heterophasic propylene copolymer has a molecular weight distribution (M_{w}/Mₙ) in the range from 4.0 to 5.5, wherein Mw stands for the weight average molecular weight and Mn stands for the number average molecular weight are measured by SEC analysis;
wherein the final heterophasic propylene copolymer shows an emission of less than 1600 mg/kg heterophasic propylene copolymer, as determined by isopropanol extraction and analysis of the extract using PTV-GC-MS; and
wherein the shifting ratio, which is the ratio of the final melt flow rate to the intermediate melt flow rate is in the range from 1.5 to 2.2.

18. The process according to claim 17, wherein the intermediate heterophasic propylene copolymer is prepared from propylene, ethylene and another α-olefin by contacting the propylene, the ethylene and the another α-olefin in the presence of a catalyst composition to obtain the intermediate heterophasic propylene copolymer,
wherein said catalyst composition is prepared by combining a procatalyst with a co-catalyst and at least one external donor to form the catalyst composition,
wherein the procatalyst is prepared by a process comprising the steps of providing a magnesium-based support, contacting said magnesium-based support with a Ziegler-Natta type catalytic species, an internal donor, and an activator, to yield a procatalyst, wherein the activator is a benzamide according to formula X: 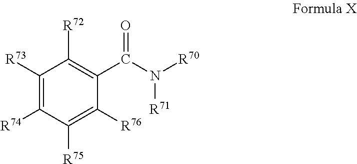
wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, and one or more combinations thereof; and wherein the internal donor is selected from the group consisting of 1,3-diethers represented by the Formula VII, 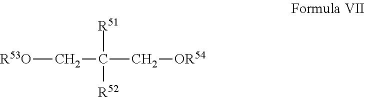
wherein R⁵¹ and R⁵² are each independently selected from a hydrogen or a hydrocarbyl group selected from alkyl, alkenyl, aryl, aralkyl, alkoxycarbonyl or alkylaryl groups, and one or more combinations thereof, and wherein R⁵³ and R⁵⁴ are each independently selected from a hydrocarbyl group.
